(19) United States
(12) Patent Application Publication
(10) Pub. No.: US 2007/0255677 A1
(43) Pub. Date: Nov. 1, 2007

(54) Method and apparatus for browsing search results via a virtual file system

(75) Inventors: Jeffrey L. Alexander, Arlington, MA (US); Stephen J. Green, Wakefield, MA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/413,641

(22) Filed: Apr. 28, 2006

(51) Int. Cl. G06F 17/30

(52) U.S. Cl. 707/1

(57) ABSTRACT

Users can browse a repository of search results obtained from a search engine by mounting a virtual file system, for example, on a network server over a network. The virtual file system contains a hierarchy of categories and is associated with a document repository. Consequently, although documents could be located anywhere, documents indexed by the virtual file system are accessed by users in the original document locations. Accordingly, all changes made by a user are made to the original document rather than to a copy of the document. Therefore, there is no need to upload a copy of the document to the original file location. The search engine can be associated with the virtual file system so that the search engine recognizes the changed document immediately.

### BACKGROUND

This invention relates to information retrieval systems and to methods and apparatus for displaying retrieved information to a user. There are many information retrieval systems that are capable of performing searches across a set of documents, which are accessible via a network, for example, a corporate or group network or intranet. Some of these documents may be owned individually, and some may be shared by a group or groups. These documents, when entered into the information retrieval system, can be assigned a category from a pre-determined hierarchy or could be assigned a category by a classification algorithm. When searching for documents, users can use the categories to browse through documents.

Although sophisticated search engines have been developed to rapidly locate documents in response to queries entered by a user, most search engines display located documents via a browsing application or a world-wide-web based interface. Such browsing applications present the retrieved documents in a serial list (often with a partial attempt at ranking the documents by relevance to the user query by placing more relevant documents at the beginning of the list). In most cases, this list includes only basic document information, such as the document title, information regarding the location of the document, such as a URL, and often the first few lines of the document. Therefore, in most cases, once a document is located, the user must actually download a copy of the document to a local drive and then open the copy in order to review it.

Further, if the user modifies the document copy, the modified copy must be uploaded to the original file location in order to overwrite the original file and preserve the modifications. However, most search interfaces only provide a means for retrieving files and do not provide a mechanism for distributing files. Therefore, in order to upload a document, some other program (such as an FTP filing program) must be used. Then, the user must wait for the search engine to re-index the document. This arrangement may not work well on multi-user systems where the users interfere with each other and on systems in which the users do not have administrative rights to the file server.

### SUMMARY

In accordance with the principles of the invention, users can browse a repository of search results obtained from a search engine by mounting a virtual file system, for example, on a network server over a network. The virtual file system contains a hierarchy of categories and is associated with a document repository. Consequently, although documents could be located anywhere, documents indexed by the virtual file system are accessed by users in the original document locations. Accordingly, all changes made by a user are made to the original document rather than to a copy of the document. Therefore, there is no need to upload a copy of the document to the original file location. The search engine can be associated with the virtual file system so that the search engine recognizes the changed document immediately.

In the virtual file system, categories can contain other categories and resources. Each category in the hierarchy has associated with it a method that determines the content of the category. When a user selects a category, each category contained within the selected category is retrieved by the virtual file system and the method in the selected category is executed causing the search engine to retrieve resources that form the content of the selected category. Any categories contained in the selected category and the retrieved resources are then presented to the user.

In one embodiment, a set of documents or a directory can be associated with a query. In this case, the virtual file system can dynamically create a category hierarchy for the results of the query. In this embodiment, a clustering algorithm automatically groups documents resulting from the query into categories and (potentially) sub-categories so that the category hierarchy is dynamically determined each time query results are obtained.

In another embodiment, repositories can be linked to the file system so that a user can browse a repository by selecting a link to the repository in the file system. When such a link is selected, the file system redirects an authorized client to another repository, causing the client to request authorization for access to a second repository.

In still another embodiment, the file system can be used to classify new documents, modify a classifier, or even to create new classifiers by adding a new document into a special “incoming” folder, adding the new document into an existing category of classified documents, and adding a collection of documents into the special “incoming” folder, respectively.

### BRIEF DESCRIPTION OF THE DRAWINGS

FIG. 1 is a block schematic diagram illustrating a virtual file server associated with a repository that contains search results generated by a search engine.

FIG. 2 is a schematic diagram illustrating one embodiment of a presentation of a search results in a file system format.

FIG. 3 is a block schematic diagram of one implementation of the file server shown in FIG. 1.

FIG. 4 is a flowchart showing the steps in an illustrative process for obtaining resources in a response to a request generated by the file system.

FIG. 5 is a schematic block diagram illustrating several representative resource objects for use with the inventive system.

### DETAILED DESCRIPTION

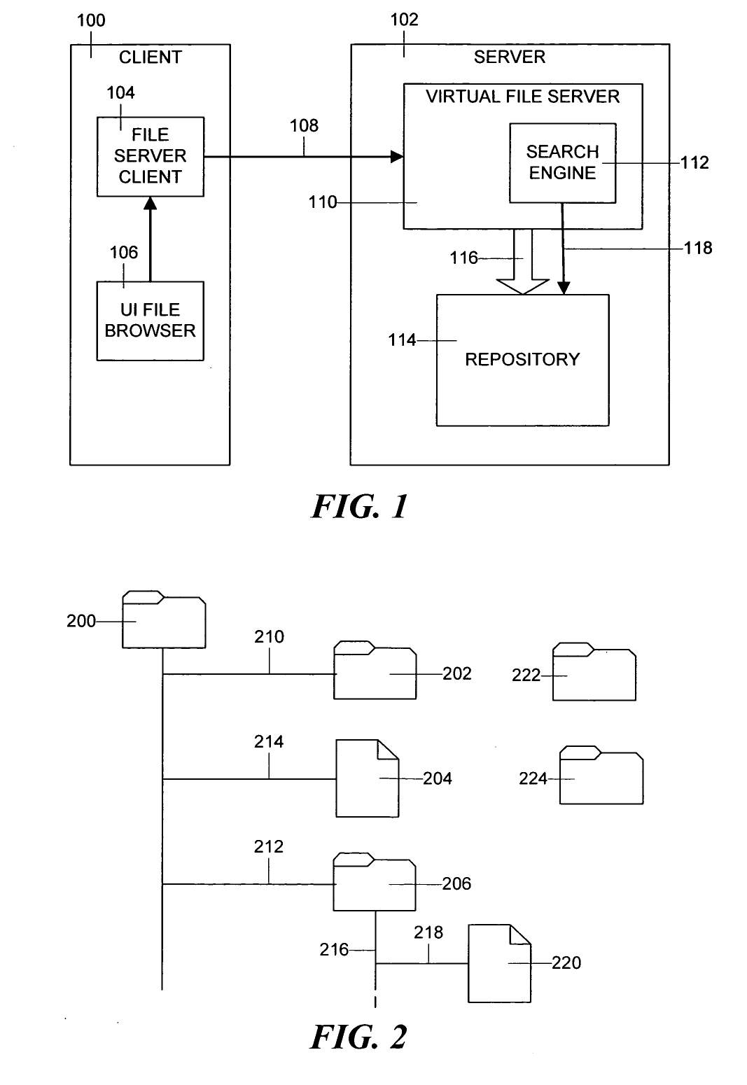

FIG. 1 illustrates the basic arrangement for browsing search results in accordance with the principles of the invention. Instead of browsing search results with a web browser or a specialized application that directly accesses documents in the repository 114 located in server 102, a virtual file system 110 is mounted by the user in the server 102. The virtual file system 110 contains a hierarchy of categories including categories that are relevant to a query posed by the user. The query could be for specific data, or a general request to view all categories starting at any level of the category hierarchy. As the user selects categories in the hierarchy, documents and other categories contained in the selected categories are presented to the user.

The virtual file system 110 is implemented in a file server 102 and mounted as indicated schematically by arrow 108 by a file server client 104 (similar, for example, to the Mac OS X Finder application) that is controlled by a user logged into a client machine 100. After the virtual file server 110 has been initialized, the user enters an identifier, such as a URL, for a virtual file server, such as server 110 that is associated with a repository 114 to which the user wants to connect. The virtual file server 110 then connects to the repository 114 as indicated schematically by arrow 116. During the connection process, the user may optionally be asked to authenticate himself or herself to the server 102 on which the repository 114 resides. The repository 114 may consist of documents which have been located, and optionally classified, by a search engine 112 as shown schematically by arrow 118. After connecting, the user can interact with documents in the repository 114 as if the documents were files in a file system. In particular, the user can view and interact with the documents using a conventional file browser user interface 106, which interacts with the file server client 104. The file server client 104, in turn, interacts with the virtual file server 110.

The repository 114 could represent a user's personal files (for example, an index of the user's home directory) or it could represent the data for a group, an organization, or even an entire enterprise. In the case of a federated search environment, thousands of small repositories could exist on a network. Users may connect to their own repositories, or, as described below, to the repositories of their peers where they may find data relevant to themselves, or to their group or enterprise level repositories. Each user will have his or her own default view or “home” folder in a repository.

The virtual file server 110 can interact with the repository 114 using a variety of conventional protocols. In one embodiment, the virtual file server 110 and the repository 114 interact via a high-level protocol, such as WebDAV. The WebDAV protocol is well-known and described in RFC 2518 “HTTP Extensions for Distributed Authoring—WEBDAV” which can be obtained from web page “www.ietf.org/rfc/rfc2518.txt”, the contents of which are hereby incorporated by reference. The WebDAV protocol is convenient because it allows individual users to authenticate and access it (without superuser privileges), it is already integrated into major desktop systems, such as JDS, KDE, Windows, Mac OS X, and it works through firewalls. In the discussion below, it will be assumed that the protocol used is WebDAV; however, those skilled in the art would understand that other conventional protocols could be used as well.

When the representation of a resource is selected, or otherwise manipulated, by a user via the file browser 106, a request is generated by the file server client 104 to the file server 110. Conventionally, this request could take many forms, including, for example, a file in extensible Markup Language (XML). Each request includes a method or command, a resource on which to apply the command and a set of parameters. For example, a request could apply a GET command to a specified resource and return the resource contents in a format specified by user context parameters. In response, the virtual file server 110 accesses the repository 114 and returns the requested data.

FIG. 2 is a schematic diagram that illustrates one embodiment of a virtual file system presentation which might constitute a home view of a user as presented in the file browser 106. In this presentation, each resource is represented by a folder, such as folders 200, 202, 206, 222 and 224. When a resource is selected, its contents can be presented. For example, as depicted by the lines 210 and 212, resources 202 and 206 are contained in resource 200. Resources, such as resources 200 and 206, may also contain documents, such as documents 204 and 220 as depicted by lines 214, 216 and 218. However, documents, such as documents 204 and 220, may not actually statically reside in their containing resources. Instead, resources can contain a query or command that can be executed by the search engine associated with the repository so that when the resource is selected, the query is used by the search engine to dynamically locate documents that are contained in that resource. A folder 224 may also be used to represent a special resource called an incoming resource. As described below, when data is added to this resource, the data is applied to the search engine which can classify the data.

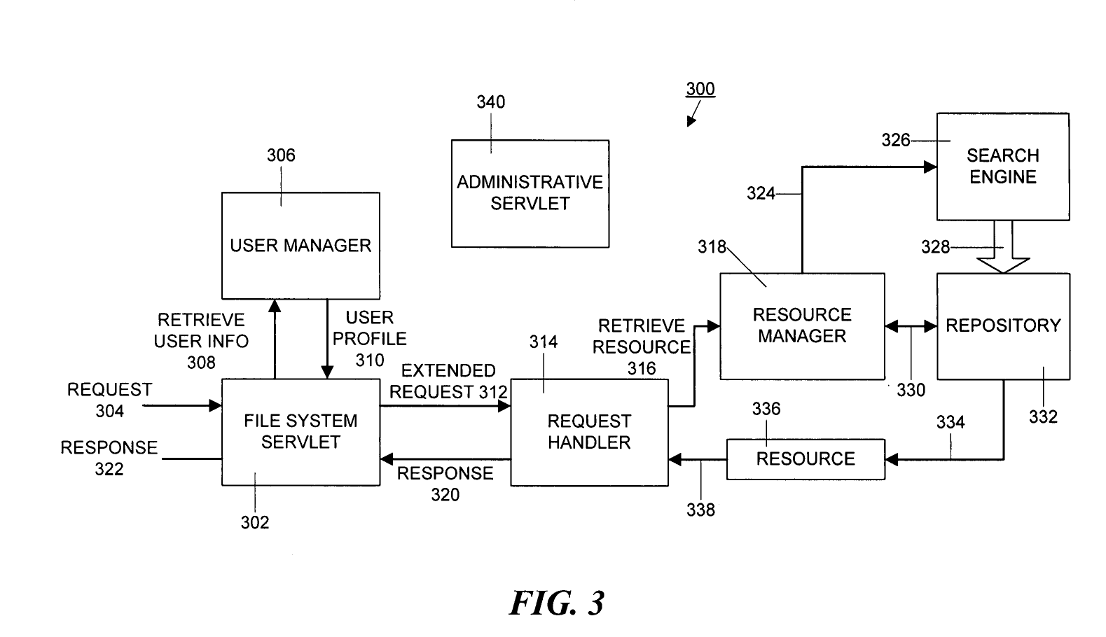

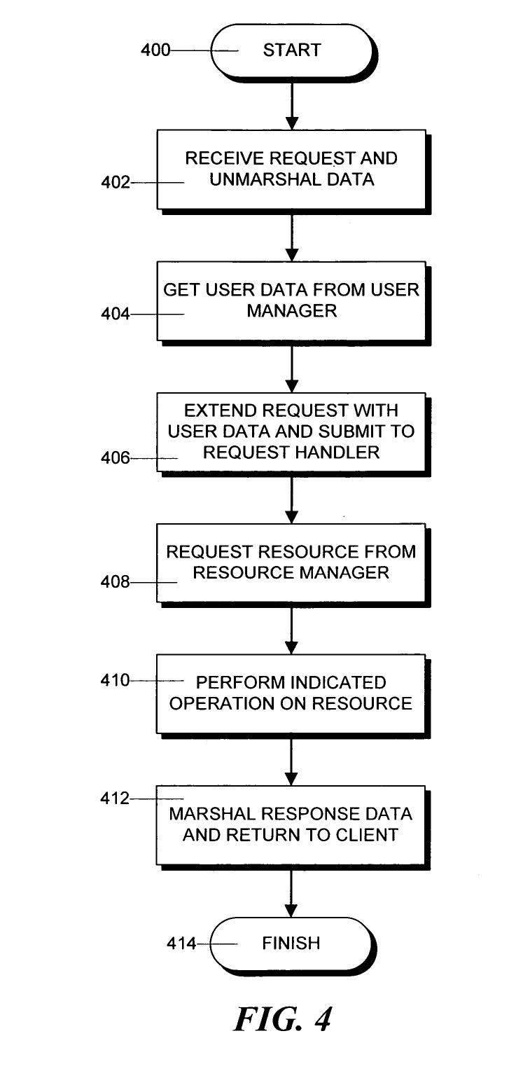

In the embodiment discussed below, the virtual file server 110 is implemented as a servlet written in the Java™ programming language for use in a conventional web server operating in the server 102. The Java™ programming language was developed by Sun Microsystems, Inc and Java is a trademark of Sun Microsystems, Inc. However, those skilled in the art would realize that the file server could be implemented in a variety of techniques, all of which are well-known. FIG. 3 is a block schematic diagram that illustrates one implementation 300 of the virtual file server 110. The steps in an illustrative process for operating the file server are shown in the flowchart of FIG. 4. This process begins in step 400 and proceeds to step 402 where the file system servlet 302 receives a request as indicated schematically by arrow 304. As discussed above, this request can be in XML format. As shown in FIG. 3, the file system servlet 302 extends the Java Servlet class so that it can be used with any one of the many conventional servlet containers. Since the file system servlet 302 is intended to implement the HTTP protocol with WebDAV extensions, the external interface to the file system servlet 302 is provided by a class that extends the Java HttpServlet class. Consequently, the file system servlet 302 must provide implementations of the standard HTTP methods, such as GET and PUT, as well as implementations of the standard WebDAV extension methods, such as PROPFIND and MKCOL.

The file system servlet 302 then unmarshals the request data from the XML request 304 and then, in step 404, interacts with the user manager 306 to get user data. When a client connects to the virtual file server 110, he or she must provide credentials to authenticate themselves with the system. The user manager 306 can allow multiple forms of authentication, and multiple forms of profile storage. For example, authentication may take the form of a conventional login process which may involve the user entering a user identification and a password.

Once a user is authenticated, the file system servlet 302 provides the user's login information to the user manager as schematically indicated by arrow 308. In response, the user manager 306 associates the user's login information with a user profile, the information of which is then returned to the file system servlet 302 and used when handling requests. Since the number of users of the system is potentially quite large, not all profiles will be stored in memory by the user manager 306. Instead, profiles that are actively in use will be kept in memory. Since the system is stateless, it is not possible to tell when a user disconnects so that a least recently used cache may be used to store user profiles. Simple files may be used or a more sophisticated form of authentication and authorization, such as systems using eXtensible Access Control Markup Language (XACML), could also be used.

As previously mentioned, each request will contain a user context (or one will be created when the user first connects). A user profile is retrieved from the user manager 306 as schematically illustrated by arrow 310 and combined with the request to form an extended request in step 406. The extended request is passed, as indicated schematically by arrow 312, to the request handler 314. Upon receiving the extended request, the request handler 314 first extracts the method or command and the resource information, typically a textual path, from the extended request. Next, the request handler 314 interacts with the resource manager 318 to retrieve the specified resource or resources as set forth in step 408.

Depending on its type, the request may require retrieval of one or more resources from the resource manager 318. If resources must be retrieved, the request handler makes a retrieval request as indicated schematically by arrow 316 to resource manager 318. Resource manager 318 enforces access permissions by checking whether the user specified in the request can perform the command that is also specified in the request on the resource. If the user has the proper access permission, the resource manager may retrieve the requested resources from the repository 332 as indicated schematically by arrow 330. Alternatively, resource manager 318 may interact with search engine 326 as indicated schematically by arrow 324, to retrieve resources, for example in response to a query contained in a requested resource. In either case, the requested resources 336 are retrieved from the repository 332 as indicated by arrow 334 and provided to the request handler 314 as indicated by arrow 338. However, if the user does not have the appropriate access permission, then access is denied.

In step 410, the request handler 314 executes the method or command in the request on the retrieved resource or resources. The request method executes, determines its response, and returns control to the request handler 314. Ultimately, the request handler 314 will return a response object to the file system servlet 302 as indicated schematically by arrow 320. In step 412, the file system servlet 302 then marshals the data in the response object and generates an XML response to the file server client 104 as indicated schematically by arrow 322. The process then finishes in step 414.

The resource manager 318 provides a standard interface to many types of resources. Resources may be indexed files, indexed email, indexed web sites, or any other data known to the search engine 112 including flat files on a file system that have not been indexed. Resources may also be sets of other resources, or collections according to WebDAV terminology, which may be defined by category names, named queries, scoring techniques, any other grouping that can be defined as output from the search engine, or by simple directories in a file system.

In order to operate with the resource manager 318, each resource, regardless of type, will expose a common interface that will provide access to both the data contained in that resource and meta-data about that resource. The exact data that is made available by this interface depends on the protocol used to access the data, in this case, WebDAV, however, any data type for which this interface can be implemented may be used as a resource.

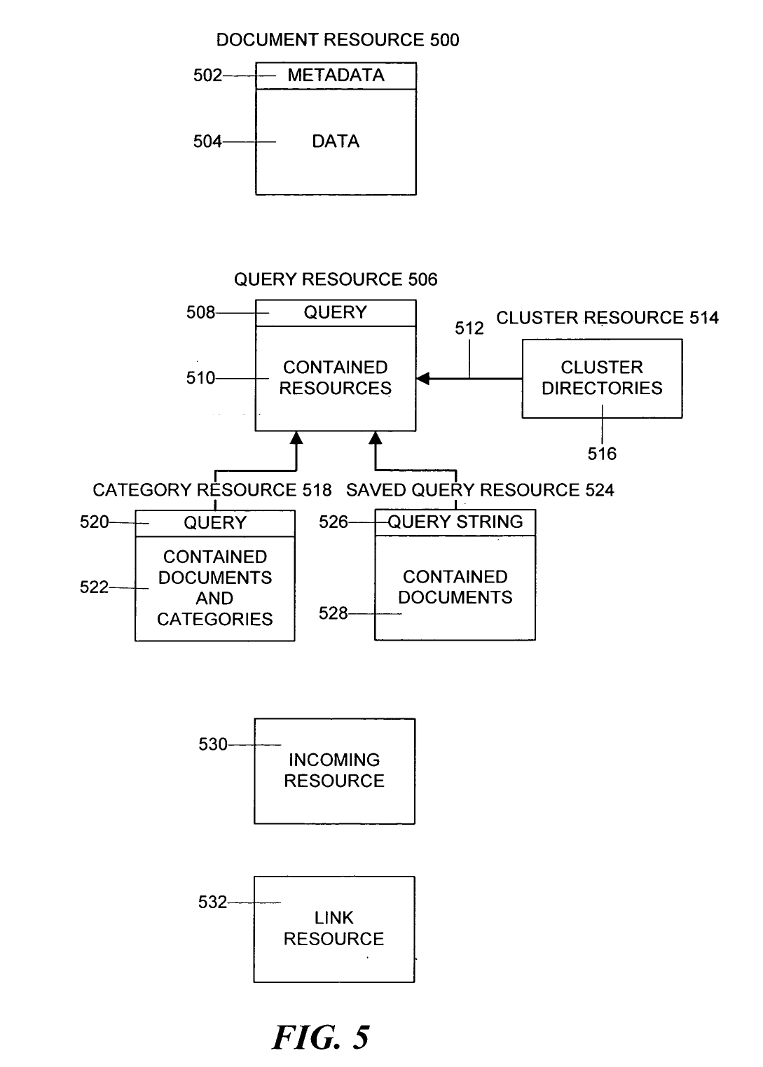

Resources in the repository 332 are represented by objects that are extensions of a generic resource type. Some of these objects are illustrated in FIG. 5 which represents resources in accordance with one embodiment of the invention. For example, a document resource object 500 represents a document. It corresponds to a file in file system terminology, or a non-collection resource in WebDAV terminology. Document resources are handles to actual data 504 and can include such meta-data 502 as creation dates, modified dates, access restrictions, names, sizes, and content data. If a GET method is performed on a document resource 500, the data 504 contained in the underlying file is returned. Similarly, if a client issues a PUT method on the document resource 500, a new document resource object 500 may be created and the data written into it. The location of the new document resource object 500 will depend on path information specified in the PUT method. Alternatively, if a PUT method is specified when editing an existing document, the contents of the existing document are replaced by the contents of the edited document.

A query resource object 506 represents a directory, or a collection in WebDAV terminology, and is a resource that contains other resources 510. It provides a method for determining the contained resources 510, for example, based on a query 508 that can be executed by the search engine 326.

In addition to the basic browsing capability over stored data, one embodiment of the file system allows the creation of a dynamic data hierarchy. For example, an option could be set to enable clustering of documents. If the clustering option were selected, each time a set of documents was selected, a conventional clustering algorithm would automatically group similar documents into folders and (potentially) sub-folders that would be dynamically created. In one embodiment, clusters are contained in a cluster resource object 514 which is a special directory that can appear as a contained resource 510 of any query resource object 506 as schematically illustrated as arrow 512. If the query resource object 506 is selected, the contents 516 of a contained cluster resource object 514 become a set of directories determined by clustering all the documents in the containing query resource object 506 using a conventional clustering algorithm. Each directory in the directory set corresponds to a cluster, and each directory contains the documents that belong in that cluster.

A category resource object 518 represents a category in a taxonomy. The category resource object 518 is instantiated from a subclass of the class used to instantiate a query resource object 506. A category resource object 518 may contain both document resource objects 500 and other category resource objects 518. A category resource object determines its contents 522 based on a query 520 of the taxonomy in the search engine 326.

The saved query resource object 524 represents a query that was saved by the user. It is instantiated from a subclass of the class used to instantiate query resource objects 506. The contents 528 of a saved query resource object 524 are defined by a customized query string 526. A saved query resource object 524 contains document resource objects 528 and the contained document resource objects 528 are created for each execution of the query specified by the query string 526. The saved query may also specify that the results of the query be clustered so that the saved query resource object also contains directories and sub-directories resulting from the clustering operation.

An incoming resource object 530 is a special type of resource that does not correspond to any resource existing in the repository 332. Instead, it represents data that should be added to the repository 332. In the file system 104 (FIG. 1) it represents a folder or place for documents to be deposited for classification and addition to the repository 332 by the search engine 326. The incoming resource object can also contain a list of files that have been added within a predetermined previous time period.

A link resource object 532 represents a link from one repository to another. Selecting a link resource causes the file server to connect to, or mount, either a new repository, or another directory in the same repository.

The file system interface provides a browsable view into the search engine repository. In addition to the file system navigation functionality provided by the WebDAV client as described above, the user can selectively change the resource index by manipulating the resources that are presented in the file system. For example, a file can be copied to a category resource object by dragging an icon representing the file to a folder icon representing the category resource object. The result is that the file is indexed and assigned to the category into which it was copied.

Similarly, a file can be copied into an incoming resource object by dragging the icon representing the file to a folder icon representing the incoming resource object. The result is that the file is indexed and classified into the taxonomy used by the search engine.

In a similar manner, a collection of documents represented by a folder icon can be manipulated by manipulating the folder icon. For example, a folder can be copied to a category resource object by dragging an icon representing the folder to a folder icon representing the category resource object. The result is that a new category is created within the resource with the name of the folder. Documents copied to the folder within a predetermined time period after the creation of the new category can be used to train a classifier for that category. Similarly, a folder can be copied into an incoming resource object by dragging the icon representing the folder to a folder icon representing the incoming resource object. The result is that files in the folder are saved into a folder in non-volatile storage and each file in the folder is indexed and classified. If a folder with the same name already exists, the classifier is removed and a new classifier is trained based on the documents added to the folder within the predetermined time period. Documents that were classified into that folder are not removed. When documents are reclassified, they may or may not be automatically classified into the new folder defined by the new classifier.

Saved queries can also be created by manipulating the file system. For example, in one embodiment, a text file containing the query on a single line by itself and with a name ending in a predefined special extension can be dragged to a folder icon representing a saved query resource. In response, a new folder is created with the query assigned to it, named with the name of the text file, minus the special extension. The new folder could still contain a file representing the query, but the file may be named with a prefix, such as leading “.” character, which is interpreted as a “hidden” file by many file browsers. Consequently, the file will not display in such a file browser. However, even in this case, an advanced user may still edit the contents of the file with an editor that can edit a text file to change the query associated with the saved query resource.

While the virtual file server provides access to data in the implementation discussed above, the protocol used does not allow any administrative activities, nor is there support for configuration in the virtual file server client. Instead, in this implementation, administrative servlets in the web server container can provide access to configuration and administration of the file server. With these administrative servlets, users will be given the ability to control what data is presented in their own “home” or starting folder, to control what saved queries are presented, what data can be shared with other users, and to create links.

In particular, an administrative servlet 340 allows a user to access configuration options that cannot be changed via the file system interactions described above. For example, the administrative servlet could be used to edit saved queries by opening the folder to which the query has been assigned and editing the query via a file with a special extension. All other data in the query folder will be read-only. The administrative servlet could also be used create link resources. Another possible use is publishing classifiers used to categorize documents. Publishing such a classifier allows a user to publish a concise description of the type of data he or she is interested in finding. The administrative servlet can be used to generate a request from a first user to a second user of the system, requesting that the second user add a new classifier to his or her repository. The first user can then add a link from his or her repository to the new classifier in the repository of the second user.

A software implementation of the above-described embodiment may comprise a series of computer instructions either fixed on a tangible medium, such as a computer readable media, for example, a diskette, a CD-ROM, a ROM memory, or a fixed disk, or transmittable to a computer system, via a modem or other interface device over a medium. The medium either can be a tangible medium, including but not limited to optical or analog communications lines, or may be implemented with wireless techniques, including but not limited to microwave, infrared or other transmission techniques. It may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, pre-loaded with a computer system, e.g., on system ROM or fixed disk, or distributed from a server or electronic bulletin board over a network, e.g., the Internet or World Wide Web.

Although an exemplary embodiment of the invention has been disclosed, it will be apparent to those skilled in the art that various changes and modifications can be made which will achieve some of the advantages of the invention without departing from the spirit and scope of the invention. For example, it will be obvious to those reasonably skilled in the art that, in other implementations, the file server could be implemented by an arrangement other than a web server. The order of the process steps may also be changed without affecting the operation of the invention. Other aspects, such as the specific process flow, as well as other modifications to the inventive concept are intended to be covered by the appended claims.

What is claimed is:

1. A method for browsing search results using a virtual file system, comprising:
(a) mounting a virtual file system containing a hierarchy of categories relevant to a specific query wherein categories at a given level in the hierarchy contain categories in levels of the hierarchy below the given level, each category having a method associated therewith which determines the content of the category;
(b) upon selection of a category in the hierarchy of categories, retrieving from the virtual file system each category contained within the selected category and executing the method in the selected category to retrieve resources from the search results in order to form the content of the selected category; and
(c) presenting categories contained in the selected category and the retrieved resources to the user.

2. The method of claim 1 wherein the search results are generated by a search engine and step (b) comprises executing the method in the selected category to cause the search engine to generate new search results.

3. The method of claim 2 wherein the selected category comprises a query that is executable by the search engine and wherein the method in the selected category causes the search engine to execute the query.

4. The method of claim 1 wherein step (b) comprises, upon selection of a category in the hierarchy of categories, clustering resources contained in the selected category to produce new categories.

5. The method of claim 1 wherein step (c) comprises using a user specific profile to determine the format of the presentation.

6. The method of claim 1 further comprising:
(d) manipulating the presentation in order to change the hierarchy.

7. The method of claim 1 wherein the virtual file system includes an incoming category, the search results are generated by a search engine and the method further comprises:
(d) placing new resources into the incoming category in order to cause the new resources to be applied to the search engine.

8. The method of claim 1 wherein the search results are stored in a repository and wherein the method further comprises:
(d) manipulating the presentation in order to change the repository.

9. The method of claim 1 wherein step (c) comprises generating a visual presentation of the categories contained in the selected category and the retrieved resources.

10. The method of claim 9 wherein each category is represented by an icon.

11. Apparatus for browsing search results using a virtual file system, comprising:
a virtual file server client that mounts a virtual file system containing a hierarchy of categories relevant to a specific query wherein categories at a given level in the hierarchy contain categories in levels of the hierarchy below the given level, each category having a method associated therewith which determines the content of the category;
a mechanism operable upon selection of a category in the hierarchy of categories, that retrieves from the virtual file system each category contained within the selected category and executes the method in the selected category to retrieve resources from the search results in order to form the content of the selected category; and
a mechanism that presents categories contained in the selected category and the retrieved resources to the user.

12. The apparatus of claim 11 wherein the search results are generated by a search engine and the mechanism that retrieves each category comprises a mechanism that executes the method in the selected category to cause the search engine to generate new search results.

13. The method of claim 2 wherein the selected category comprises a query that is executable by the search engine and wherein the method in the selected category causes the search engine to execute the query.

14. The apparatus of claim 11 wherein the mechanism that retrieves each category comprises, a mechanism operable upon selection of a category in the hierarchy of categories, that clusters resources contained in the selected category to produce new categories.

15. The apparatus of claim 11 wherein the mechanism that presents categories to the user comprises a mechanism that uses a user specific profile to determine the format of the presentation.

16. The apparatus of claim 11 further comprising a mechanism that manipulates the presentation in order to change the hierarchy.

17. The apparatus of claim 11 wherein the virtual file system includes an incoming category, the search results are generated by a search engine and the apparatus further comprises a mechanism that places new resources into the incoming category in order to cause the new resources to be applied to the search engine.

18. The apparatus of claim 11 wherein the search results are stored in a repository and wherein the apparatus further comprises a mechanism that manipulates the presentation in order to change the repository.

19. The apparatus of claim 11 wherein the mechanism that presents categories to the user comprises a mechanism that generates a visual presentation of the categories contained in the selected category and the retrieved resources.

20. Apparatus for browsing search results using a virtual file system, comprising:
means for mounting a virtual file system containing a hierarchy of categories relevant to a specific query wherein categories at a given level in the hierarchy contain categories in levels of the hierarchy below the given level, each category having a method associated therewith which determines the content of the category;
means operable upon selection of a category in the hierarchy of categories, retrieving from the virtual file system each category contained within the selected category and executing the method in the selected category to retrieve resources from the search results in order to form the content of the selected category; and
means for presenting categories contained in the selected category and the retrieved resources to the user.
